(19) United States
(12) Patent Application Publication
(10) Pub. No.: US 2012/0159376 A1
(43) Pub. Date: Jun. 21, 2012

(54) EDITING DATA RECORDS ASSOCIATED WITH STATIC IMAGES

(75) Inventor: William M. Crow, Sequim, WA (US)

(73) Assignee: MICROSOFT CORPORATION, Redmond, WA (US)

(21) Appl. No.: 12/968,280

(22) Filed: Dec. 15, 2010

(51) Int. Cl. G06F 3/048

(52) U.S. Cl. 715/780

(57) ABSTRACT

Embodiments provide in-place editing of data records via an editable visual representation within a displayed collection of static images. Each of the static images corresponds to at least one data record having at least one field. The field is non-editable by the user via the image. The plurality of images is provided to the user for browsing, navigation, searching, and the like. In response to the user selecting at least one of the displayed images, the selected image is converted to a layout-based visual representation having editable fields. The user interacts with the visual representation to add, modify, and/or delete data associated with the data record. The data record is updated, and the selected, static image is regenerated with the data from the user.

### BACKGROUND

Large datasets including thousands of data records are difficult to visualize. In some existing systems, each row in a spreadsheet represents a data record and the columns within a row represent the fields that include field values and constitute the data record. To enable users to understand the data, some existing viewing systems enable the users to represent the data records from the dataset as graphs, charts, or other diagrams. These static images are displayed the user. To change the data, the user edits the underlying data in the spreadsheet, then re-creates the graph, charts, or other diagram.

Some existing systems enable the user to visualize the data from the dataset by providing an interactive browsing experience. The data records are converted to static images and displayed to the user. The static images are read-only, however, requiring the user to go back to the spreadsheet to make any changes to the data in the spreadsheet. While such existing systems provide a fluid browsing experience, these systems fail to provide in-place editing capabilities for the users.

### SUMMARY

Embodiments of the disclosure enable visualization of large sets of data records using multiscale images while providing users with the ability to edit the data records during the visualization. A plurality of images is generated for display to a user. Each of the images corresponds to at least one data record having at least one data field. The field is non-editable by the user via the plurality of images. The generated plurality of images is provided to the user for display. A selection of at least one of the displayed plurality of images is received from the user. The selected image is converted to a visual representation with the field being editable therein. The visual representation is provided to the user for display. Data for associated with the field is received from the user via the displayed visual representation. The received data is stored in the field in the data record corresponding to the visual representation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a user interacting with a computing device to visualize a large collection of data records.

FIG. 2 is an exemplary flow chart illustrating operation of the computing device to enable the user to edit data records associated with displayed images.

FIG. 3 is an exemplary image, without editable fields, displaying data from a data record.

FIG. 4 is an exemplary histogram comprising a plurality of images each corresponding to at least one data record.

FIG. 5A is an exemplary data record image having underlying data that is not editable by the user in the current form of the data record image.

FIG. 5B is the exemplary data record image from FIG. 5A that has been converted to a visual representation that includes an editable field for data entry by the user.

FIG. 6 is an exemplary block diagram illustrating user entry of data into a data record image that has been converted to a visual representation that includes editable fields.

Corresponding reference characters indicate corresponding parts throughout the drawings.

### DETAILED DESCRIPTION

Referring to the figures, embodiments of the disclosure enable in-place editing of data records 114 during visualization of the data records 114 as static images (e.g., trade cards). In some embodiments, a user 102 visualizes thousands of the trade cards with little to no latency and high performance, resolution-based progressive rendering of the trade cards. The user 102 selects a trade card for editing, and the trade card is replaced with an editable visual representation of the trade card. The user 102 is able to add, modify, and/or delete data within the data record 114 via the editable visual representation.

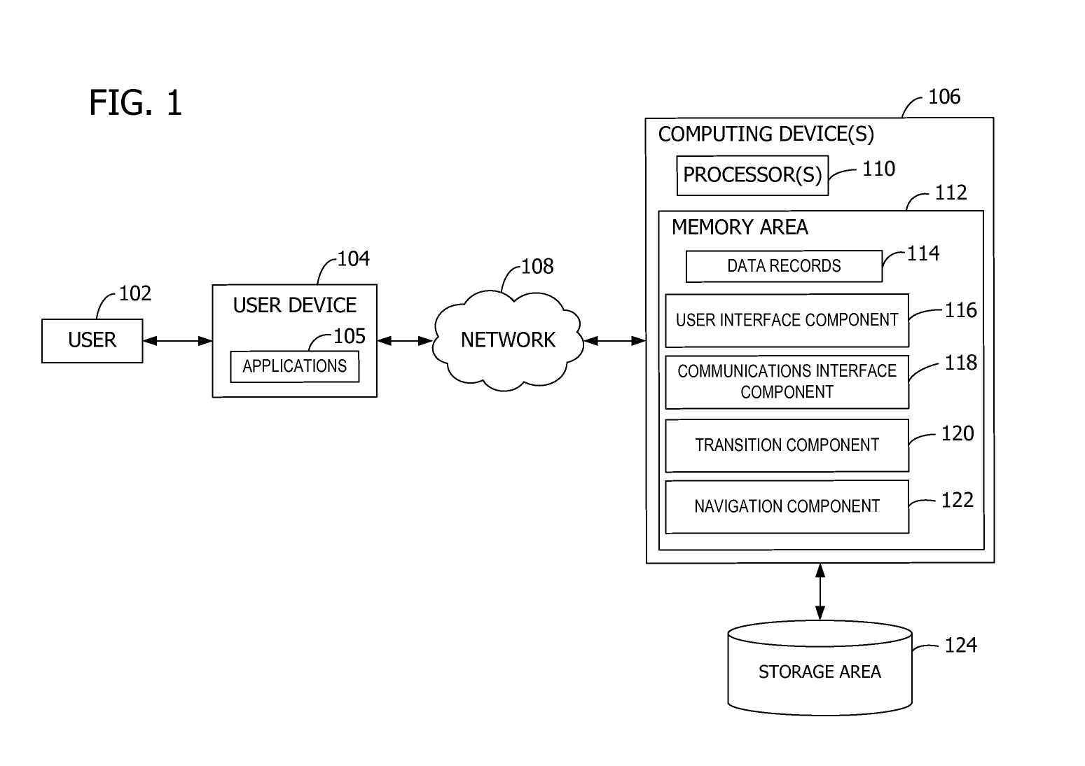

Referring again to FIG. 1, an exemplary block diagram illustrates user 102 interacting with a computing device 106 to visualize a large collection of data records 114. In the example of FIG. 1, the user 102 interacts with a user device 104 to communicate with the computing device 106 via a network 108. The user device 104 includes any computing device such as a mobile computing device (e.g., mobile telephone, laptop, netbook, gaming device, and/or portable media player) or less portable devices such as desktop personal computers, kiosks, and tabletop devices. The user 102 interacts with the user device 104 is any way to visualize the data records 114, or portions thereof. For example, the user device 104 may include a display (e.g., a touch screen display) and/or computer-executable instructions (e.g., a driver) for operating the display. The user device 104 may also include one or more of the following to provide data to the user 102 or receive data from the user 102: speakers, a sound card, a camera, a microphone, a vibration motor, and one or more accelerometers. For example, the user 102 may input commands or manipulate data by moving the user device 104 in a particular way.

The user device 104 executes one or more applications 105. The applications 105, when executed, operate to perform functionality on the user device 104 and provide data to the user 102. Exemplary applications 105 include mail application programs, web browsers, calendar application programs, address book application programs, messaging programs, media applications, location-based services, search programs, and the like. The applications 105 may communicate with counterpart applications or services such as web services accessible via the network 108. For example, the applications 105 may represent downloaded client-side applications that correspond to server-side services executed in part by the computing device 106 in a cloud.

The network 108 includes any form, type, or combination of networks including, but not limited to, the Internet, a wired network, a wireless network, a local area network, or a peer-to-peer network.

The computing device 106 represents any device executing instructions (e.g., as application programs, operating system functionality, or both) to implement the operations and functionality described herein. Additionally, the computing device 106 may represent a group of processing units or other computing devices. In some embodiments, the computing device 106 is associated with a cloud computing service providing processing and storage functionality to the user device 104.

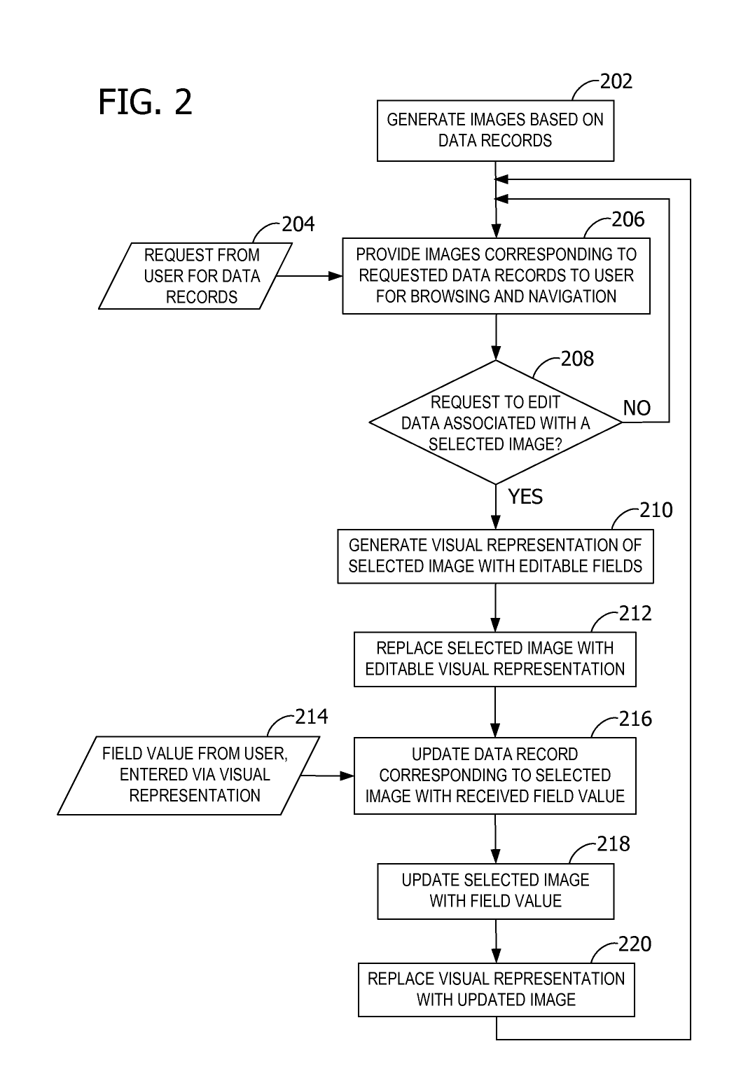

The computing device 106 has at least one processor 110 and a memory area 112. The processor 110 includes any quantity of processing units, and is programmed to execute computer-executable instructions for implementing aspects of the disclosure. The instructions may be performed by the processor 110 or by multiple processors executing within the computing device 106, or performed by a processor external to the computing device 106. In some embodiments, the processor 110 is programmed to execute instructions such as those illustrated in the figures (e.g., FIG. 2).

The computing device 106 further has one or more computer-readable media such as the memory area 112. The memory area 112 includes any quantity of media associated with or accessible by the computing device 106. The memory area 112 may be internal to the computing device 106 (as shown in FIG. 1), external to the computing device 106 (shown by storage area 124), or both.

The memory area 112 stores one or more data records 114. While described as “records,” the data records 114 represent any data stored in any format, configuration, structure, organization, or type. For example, the data records 114 may include one or more of the following: text data, binary large object data, spreadsheet data, images, audio, video, and/or database data. The data records 114 may be stored in the memory area 112 as shown in FIG. 1 and/or stored in the storage area 124 external to the computing device 106. In some embodiments, each data record 114 has one or more fields associated therewith. Each field corresponds to a particular element or item of data.

The memory area 112 further stores one or more computer-executable components. Exemplary components include a user interface component 116, a communications interface component 118, a transition component 120, and a navigation component 122. The components, when executed by the processor 110, enable changes to field values in multiscale images, as described next with reference to FIG. 2.

Referring next to FIG. 2, an exemplary flow chart illustrates operation of the computing device 106 to enable the user 102 to edit data records 114 associated with displayed images. At 202, a plurality of images is generated. Each of the images corresponds to at least one of the data records 114, or a portion thereof. In some embodiments, each of the images corresponds to a row of data values in a table (e.g., in a spreadsheet). The images are created, in some embodiments, based on a layout-based template that is customizable by the user 102. For example, the user 102 maps selected field in the data records 114 to one or more visual elements within the template. The computing device 106 generates the images by applying the template to the data records 114. In some embodiments, the user 102 further customizes the visual elements within the template (e.g., color, size, position, font, font attribute, transparency, fill, line weight, background content, text content, and the like). Additional exemplary visual elements include fields allowing the user 102 to reference still images, video data, and audio data.

The images generated by the computing device 106 are static in that the corresponding data record 114 is not editable by the user 102 via the image. For example, the images are generated as bitmaps or in joint photographic experts group (JPEG) format. The operation at 202 may be performed at any time prior to receiving a request from the user 102 to view one or more of the data records 114, or may be performed in response to receiving such a request from the user 102.

At 204, a request is received from the user 102 for one or more of the records. At 206, the computing device 106 provides the images corresponding to the requested data records 114 to the user 102. The user 102 communicates with the computing device 106 to browse, navigate, organize, arrange, or otherwise interact with the provided images. For example, the user 102 may view a subset of the provided images, request additional images, search for particular data, filter for particular data, and the like. In another example, the user 102 zooms in or out of the displayed images (e.g., the user 102 identifies a zoom level) such as from viewing a single image or subregion of an image to viewing the entire collection of images.

While visualizing the data records 114 via the displayed images, the user 102 may select one or more of the displayed images and desire to alter the data record(s) associated therewith. If the computing device 106 receives a request from the user 102 to edit the data record 114 associated with one of the images at 208, or otherwise receives a selection of at least one of the images for editing, the computing device 106 converts the selected image to a visual representation wherein the fields associated with the underlying, corresponding data record 114 are editable by the user 102 via the visual representation. For example, the computing device 106 generates the visual representation from the selected image at 210, and replaces the selected image displayed to the user 102 with the generated visual representation at 212. Replacing the selected image with the generated visual representation includes providing the visual representation for display to the user 102.

In some embodiments, the computing device 106 converts the static image into a layout-based template wherein the fields are accessible by the user 102 for editing. For example, the static image is converted to a hypertext markup language (HTML) template.

At 214, the computing device 106 receives a field value from the user 102 for association with the data record 114 corresponding to the visual representation. For example, the user 102 enters the field value into the editable field in the visual representation displayed to the user 102. The field value is then sent, for example, by the user device 104 to the computing device 106 via the network 108. The field value includes any data for association with the data record 114. For example, the data input by the user 102 may include text data, binary data, an image, an audio clip, and/or a video clip. The user 102 may further create new columns or rows of data for association with the selected image. In some embodiments, the user 102 is able to remove entire data records 114 from the dataset by deleting the displayed image.

At 216, the computing device 106 updates the data records 114 corresponding to the selected image with the received field value. For example, if only one data record 114 is associated with the displayed visual representation, then that data record 114 is updated (e.g., the field value is stored within the data record 114). In another example, the visual representation may include data from a plurality of the data records 114. In such an example, the computing device 106 identifies the plurality of data records 114 affected by the field value received from the user 102, and updates the identified data records 114 with the received field value.

In some embodiments, the field value received by the user 102 may affect a plurality of the images currently displayed to the user 102. In such embodiments, the computing device 106 identifies the plurality of images affected by the received data, and replaces each of the identified images with updated images reflecting the received data. For example, the computing device 106 re-generates the affected images and provides the re-generated images to the user 102 for display.

At 218, the computing device 106 updates the selected image with the field value received from the user 102. For example, the computing device 106 re-generates the static image using the data record 114 with the updated field value, and provides the re-generated static image to the user 102 for display. At 220, the editable visual representation is replaced with the re-generated static image. The user 102 then proceeds to browse, navigate, or otherwise interact with the plurality of displayed images.

In some embodiments, the images are multiscale or multi-resolution images. The multiscale images are displayed to the user 102 in a resolution-based, progressive rendering format to enable visual exploration of a large set of the data records 114. In such embodiments, there are different versions of the images with each of the versions corresponding to a different resolution. The version displayed to the user 102 depends on a zoom level requested by the user 102. For example, low resolution versions are displayed if the user 102 requests to view the images from a high level, while high resolution versions are displayed if the user 102 requests to view the images close-up. The low resolution images may visualize less of the data from the corresponding data records 114. At a pre-defined zoom level, the images may be replaced with a pre-defined alternate image of reduced resolution. For example, each image may be replaced with a logo or other specific shape (e.g., circle, square, triangle, etc.) and/or color when at the pre-defined zoom level. As the user 102 adjusts the zoom level, the images may display a subset of the fields from the corresponding data record 114. The data record 114 associated with each image version, however, is not editable by the user 102 until the user 102 selects the image version for editing and is presented with the editable visual representation (e.g., as illustrated in FIG. 2).

The operations illustrated in FIG. 2 may be implemented by the components illustrated in FIG. 1. For example, the user interface component 116, when executed by the processor 110, causes the processor 110 to provide to the user 102 a browsable collection of the images corresponding to the data records 114. The data records 114 are non-editable by the user 102 via the images (e.g., the user 102 cannot interact with the static images to edit the corresponding data records 114). The navigation component 122, when executed by the processor 110, causes the processor 110 to receive commands from the user 102 for browsing the collection of images provided by the user interface component 116. For example, the navigation component 122 enables the user 102 to adjust a zoom level of the collection of images provided by the user interface component 116.

The communications interface component 118, when executed by the processor 110, causes the processor 110 to receive a request from the user 102 to edit at least one of the records associated with one of the images provided by the user interface component 116. In some embodiments, the communications interface component 118 includes a network interface card and/or computer-executable instructions (e.g., a driver) for operating the network interface card.

The transition component 120, when executed by the processor 110, causes the processor 110 to transition at least one of the images provided by the user interface component 116 to a visual representation having editable fields. The user 102 interacts with the editable visual representation to edit the data record 114 corresponding to the editable visual representation. The user interface component 116 receives a field value from the user 102 via the visual representation. The transition component 120 applies the field value received by the user interface component 116 to the data record 114 associated with the visual representation. The transition component 120, or the user interface component 116, re-generates the selected image, and any other affected images, with the received field value. The user interface component 116 provides the image updated with the field value to the user 102 for display to replace the editable visual representation.

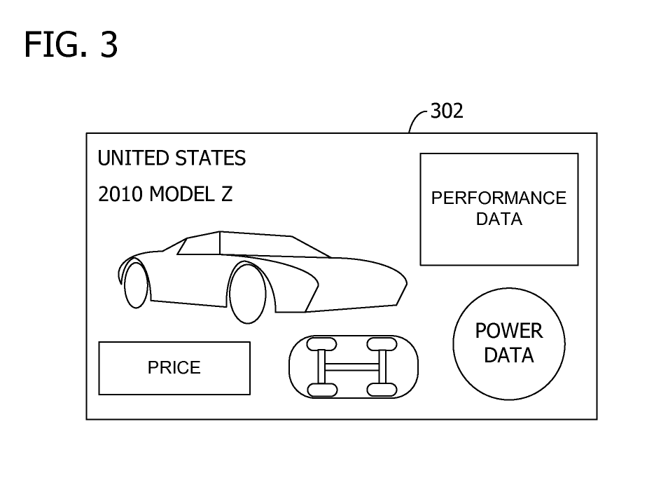

Referring next to FIG. 3, an exemplary image 302, without editable fields, displays data from a data record such as data record 114. The image 302 in the example of FIG. 3 may be referred to as a trade card, and in this example shows performance data relating to a sports car. The trade card is static in that it conveys data from one or more data records 114 corresponding thereto, but is not directly editable. That is, the user 102 is unable to edit the displayed data by interacting with the trade card.

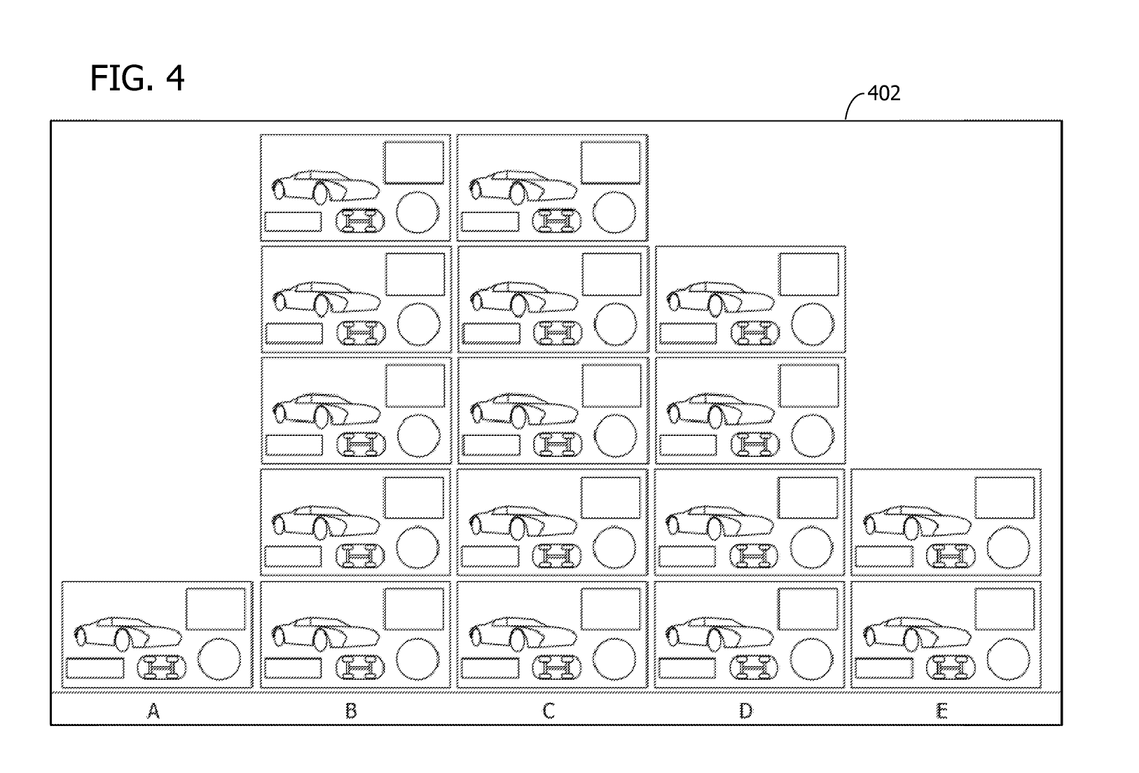

Referring next to FIG. 4, an exemplary histogram 402 comprises a plurality of images each corresponding to at least one data record such as data record 114. The images in the example of FIG. 4 are trade cards arranged in the form of a histogram 402. The arrangement may be based on a data from a row or column of an underlying spreadsheet. The user 102 is able to manipulate display of the trade cards, but is unable to edit the underlying spreadsheet data via the static trade cards.

While the example in FIG. 4 is the histogram 402, aspects of the disclosure enable the user 102 to sort, subset, and/or organize any view including a grid, two-dimensional histogram, sequential diagram, cluster, map, and the like.

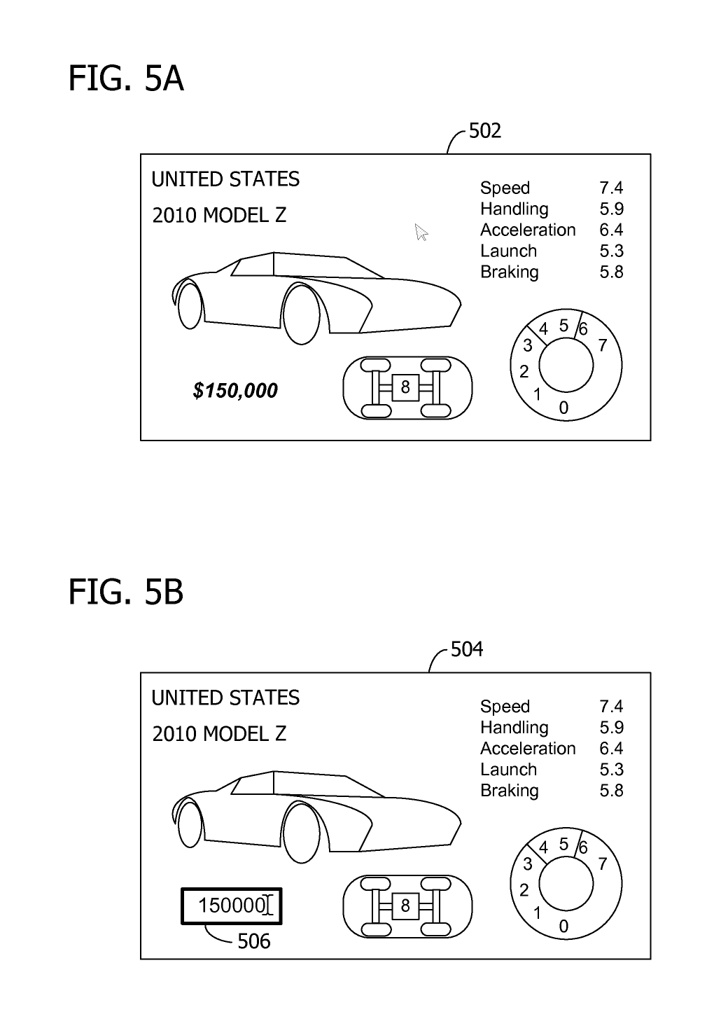

Referring next to FIG. 5A, an exemplary data record image 502 (e.g., a spreadsheet trade card) displays data associated with an automobile. The data record image 502 is static at least in that the displayed data cannot be edited by the user 102.

Referring next to FIG. 5B, the exemplary data record image 502 from FIG. 5A has been converted to a visual representation 504 that includes at least one editable field 506 for data entry by the user 102. The data record image 504 shown in FIG. 5B is a trade card that the user 102 has selected for editing. For example, the user 102 clicked, double-clicked, hovered over, or otherwise selected or activated the displayed data record image 502 (e.g., double-clicked on the price). Upon receipt of the selection, the computing device 106 converted the static displayed image 502 to a layout-based template (e.g., visual representation 504) having at least one editable field 506. The editable field 506 in FIG. 5B is ready for text entry by the user 102. The static image 502 was then replaced with the visual representation 504 for display to the user 102 to enable receipt of edits from the user 102. In the example of FIG. 5B, the user 102 is changing the price of the automobile. Upon receipt of the adjusted price from the user 102, the computing device 106 updates the data record 114 corresponding to the visual representation 504 by storing the adjusted price in the data record 114, and replaces the editable visual representation 504 with a static image that has been updated with the adjusted price.

In other embodiments (not shown), the user selects other data for editing such as the performance data, model name, and/or country of origin.

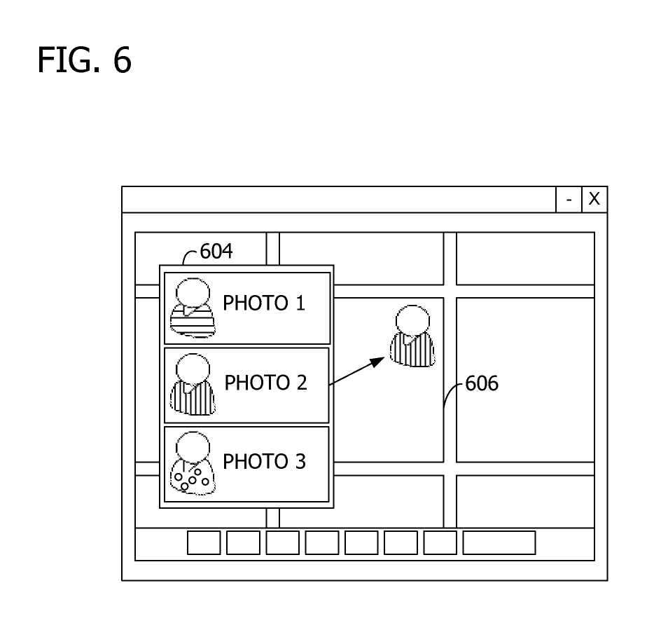

Referring next to FIG. 6, an exemplary block diagram illustrates user entry of data into a data record image that has been converted to a visual representation 606 that includes editable fields. The data record image shown in FIG. 6 is a trade card that the user 102 has selected for editing. In the example of FIG. 6, the user 102 is adding a photograph to the selected trade card by dragging and dropping the photograph from one portion 604 of the user interface into the editable visual representation 606. After the user 102 deposits the photograph into the editable visual representation 606, the computing device 106 updates the data record 114 corresponding to the visual representation 606 by storing the photograph in the data record 114 (or otherwise associating the photograph with the data record 114), and replaces the editable visual representation 606 with a static image that has been updated with the photograph.

In the example of FIG. 6, while the selected trade card is converted to the editable visual representation 606, the other displayed images remain non-editable.

While embodiments are described with reference to a single static image being selected by the user 102 and converted by the computing device 106 to an editable format, aspects of the disclosure are operable with the user 102 selecting a plurality of the displayed images for editing. Continuing the example shown in FIG. 6, the user 102 may select two images to receive the photograph.

### Additional Examples

In some embodiments, the data records 114 associated with the images are displayed to the user 102 along with the images (e.g., either with or without an editable visual representation) in the same user interface on the user device 104. For example, the user interface component 116 executes to provide a spreadsheet containing the data records 114. In such embodiments, the user interacts with the displayed spreadsheet, and the interaction affects the displayed collection of images. For example, the user 102 may select a quantity of rows and/or columns (e.g., data records 114) of the spreadsheet, and the images corresponding to the selected rows/columns are displayed to the user 102.

In an example, embodiments of the disclosure provide a plurality of pre-defined templates for use when converting the static images to the editable visual representation. Each of the templates may apply, for example, to a particular type of data record 114 (e.g., financial data, performance data, etc.).

In some embodiments, the static images are included as markers in a chart, line graph, or other diagram. For example, miniaturized views of the static images are used to represent the underlying data in the chart. The user 102 can zoom in or out of the chart to view the static image, and select a particular image for conversion to the editable template for editing the underlying data record 114.

At least a portion of the functionality of the various elements in FIG. 1 may be performed by other elements in FIG. 1, or an entity (e.g., processor, web service, server, application program, computing device, etc.) not shown in FIG. 1.

In some embodiments, the operations illustrated in FIG. 2 may be implemented as software instructions encoded on a computer-readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users 102. In such embodiments, notice is provided to the users 102 of the collection of the data (e.g., via a dialog box or preference setting) and users 102 are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for providing the plurality of data records 114 to the user 102 as a browsable collection of the multiscale images while simultaneously enabling in-place editing of the data record 114 corresponding to one of the multiscale images, and exemplary means for transitioning between the multiscale image with non-editable fields and the corresponding visual representation with editable fields during browsing by the user 102 of the displayed multiscale images.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for enabling changes to field values in multiscale images, said system comprising:
a memory area associated with a computing device, said memory area storing a plurality of data records, each of the plurality of data records having one or more fields associated therewith;
a processor associated with the computing device, said processor programmed to:
generate multiscale images each corresponding to at least one of the plurality of data records stored in the memory area;
provide the generated multiscale images to the user for display, wherein the fields associated with said at least one of the data records are non-editable by the user via the displayed multiscale images;
receive a selection from the user of at least one of the displayed multiscale images;
replace the selected multiscale image with a visual representation having fields editable by the user;
receive, from the user via the visual representation, a field value associated with at least one of the fields in the visual representation;
store the received field value with the corresponding data record in the memory area; and
replace the visual representation with the selected multiscale image updated to reflect the received field value.

2. The system of claim 1, wherein the processor is further programmed to receive a request from the user to display one or more of the plurality of data records.

3. The system of claim 1, wherein the processor is programmed to replace the selected multiscale image by:
generating the visual representation having fields editable by the user; and
providing the generated visual representation to the user for display.

4. The system of claim 1, wherein the processor is programmed to replace the visual representation by:
generating an updated multiscale image with the received field value; and
providing the generated, updated multiscale image to the user for display.

5. The system of claim 1, further comprising means for providing the plurality of data records to the user as a browsable collection of the multiscale images while simultaneously enabling in-place editing of the data record corresponding to one of the multiscale images.

6. The system of claim 1, further comprising means for transitioning between the multiscale image with non-editable fields and the corresponding visual representation with editable fields during browsing by the user of the displayed multiscale images.

7. A method comprising:
generating, for display to a user, a plurality of images each corresponding to at least one data record having at least one field, wherein the field is non-editable by the user via the plurality of images;
providing the generated plurality of images for display to the user;
receiving a selection from the user of at least one of the displayed plurality of images;
converting the selected image to a visual representation with the field being editable therein;
providing the visual representation for display to the user;
receiving, from the user via the displayed visual representation, data for association with the field; and
storing the received data in the field in the data record corresponding to the visual representation.

8. The method of claim 7, further comprising:
identifying the plurality of images affected by the received data; and
updating the identified images with the received data.

9. The method of claim 7, wherein converting the selected image comprises generating the visual representation with the field being editable therein.

10. The method of claim 7, wherein converting the selected image comprises generating a layout-based template encoded in hypertext markup language.

11. The method of claim 7, wherein generating the plurality of images comprises generating a plurality of multi-resolution images.

12. The method of claim 7, wherein generating the plurality of images comprises generating a plurality of bitmaps each corresponding to at least one data record having at least one field, wherein the field is non-editable by the user via the plurality of bitmaps.

13. The method of claim 7, wherein providing the generated plurality of images comprises providing the generated plurality of images at a zoom level identified by the user.

14. The method of claim 7, wherein generating the plurality of images comprises generating a plurality of images each corresponding to a row in a spreadsheet.

15. The method of claim 7, wherein the data record is one of a plurality of data records in a large dataset, and wherein providing the generated plurality of images comprises providing the generated plurality of images in a resolution-based progressive rendering format to enable visual exploration of the large dataset.

16. The method of claim 7, further comprising replacing the displayed plurality of images with pre-defined alternate images of reduced resolution based on a zoom level selected by the user.

17. One or more computer-readable media having computer-executable components, said components comprising:
a user interface component that when executed by at least one processor causes the at least one processor to provide to a user a browsable collection of images corresponding to data records, wherein the data records are non-editable by the user via the images;
a communications interface component that when executed by at least one processor causes the at least one processor to receive a request to edit one of the records associated with one of the images provided by the user interface component; and
a transition component that when executed by at least one processor causes the at least one processor to transition said one of the images provided by the user interface component to a visual representation having editable fields, wherein the user interface component receives a field value from the user via the visual representation, wherein the transition component applies the field value received by the user interface component to the data record associated with said one of the images, and wherein the user interface component updates said one of the images with the field value received by the user interface component.

18. The computer-readable media of claim 17, further comprising a navigation component that when executed by at least one processor causes the at least one processor to receive commands from the user for browsing the collection of images provided by the user interface component.

19. The computer-readable media of claim 18, wherein the navigation component further executes to receive commands from the user for adjusting a zoom level of the collection of images provided by the user interface component.

20. The computer-readable media of claim 17, wherein the user interface component further executes to provide, to the user for display with the collection of images, a spreadsheet containing the data records, wherein user interaction with the displayed spreadsheet affects the displayed collection of images.
